(19) United States
(12) Patent Application Publication
(10) Pub. No.: US 2006/0180101 A1
(43) Pub. Date: Aug. 17, 2006

(54) Hydrogen-oxygen production device

(76) Inventor: Gregory R. Monette, Anchorage, AK (US)

Correspondence Address: BRACEWELL & GIULIANI LLP, P.O. BOX 61389, HOUSTON, TX, 77208-1389, US

(21) Appl. No.: 11/354,388

(22) Filed: Feb. 15, 2006

Related U.S. Application Data
(60) Provisional application No. 60/653,438, filed on Feb. 16, 2005.

(51) Int. Cl. F02B 43/08

(52) U.S. Cl. 123/3; 123/527

(57) ABSTRACT

A system for supplying power with a combustion engine includes an engine having fuel and air intake lines, and an exhaust line. The engine has a combustion chamber volume defining a number of liters of engine displacement. A fuel cell has a gas outlet that communicates with the air intake line, and selectively produces hydrogen and oxygen gases through an electrolysis process. An oil pressure sensor communicates with the engine to sense when the engine is operating. A switch communicates with the sensor and is closed when the sensor senses that the engine is operating. The switch is open when the sensor senses that the engine is not operating. A battery communicates with the fuel cell and selectively supplies electrical power for the electrolysis process when the switch is closed.

### 1. FIELD OF THE INVENTION

This invention relates in general to devices for producing hydrogen and oxygen for injection into engines powered by gasoline or diesel.

### 2. BACKGROUND OF THE INVENTION

There are two major problems in the operation of fossil fueled vehicles that have existed for some time. The first is the apparently limited supply of fossil fuels. The second is the pollution that these vehicles produce. Even if the supply of fossil fuels expands, it is still good policy to conserve as much as practical. One of the key concerns of conservation is the cost of the particular measure. So, the ideal conservation measure is one that produces significant reductions in fuel use at the lowest possible cost.

The second problem centers on the emissions produced when burning fossil fuels. Vehicles burning such fuels often produce carbon monoxide, nitrous oxides, sulfur dioxide and other noxious gasses. These products are a result, in part, of engines not completely burning the fuel.

It has long been known that hydrogen is a near perfect fuel. It releases almost three times the energy of fossil fuels when burned, it produces only water as the product of combustion, and it can be readily produced from water by electrolysis. Despite these advantages, hydrogen has one serious drawback—it is highly explosive. Thus, it has not proved practical to operate vehicles using pure hydrogen as a fuel source. Moreover, although it can be readily produced from water, it takes energy to produce the hydrogen, which typically is produced from fossil fuel sources.

Despite these drawbacks, considerable research has been done on the effects of mixing hydrogen with gasoline in motor vehicles. We know that mixing hydrogen with gasoline and air in the combustion chamber of a conventional engine produces improved thermal efficiency and a reduction in emissions of pollutants. Although tests have shown that mixing hydrogen with gasoline and air in the combustion chamber can reduce pollution, there has not been prior art that devices have also reduced the horsepower and therefore the performance of the engine. Moreover, no one has determined the optimum amount of hydrogen and oxygen gases from hydrogen-oxygen fuel cells to mix with the air and fuel in the combustion chambers of engines.

### SUMMARY OF THE INVENTION

In order to reduce emissions and improve engine performance, a system for supplying power with a combustion engine includes a combustion engine having a fuel intake line, an air intake line, and an exhaust line. The fuel intake line receives fuel from a fuel source and the air intake line receives filtered air from an air source. The fuel can be diesel or regular gasoline. The combustion engine has a combustion chamber volume defining a predetermined number of liters of engine displacement. A hydrogen-oxygen fuel cell has a gas outlet in fluid communication with the air intake line. The hydrogen-oxygen fuel cell selectively produces hydrogen and oxygen gases through an electrolysis process. An oil pressure sensor is also in fluid communication with the combustion engine. The oil pressure sensor senses when the combustion engine is operating. A switch is in communication with the oil pressure. The switch is in a closed position when the oil pressure sensor senses that the combustion engine is operating. The switch is in an open position when the oil pressure sensor senses that the combustion engine is not operating. A battery is in electrical communication with the hydrogen-oxygen fuel cell that selectively supplies electrical power for the electrolysis process when the switch is in a closed position.

The hydrogen-oxygen fuel cell can supply between about 50 and 90 cubic centimeters of hydrogen and oxygen gases per minute, per liters of engine displacement. The hydrogen-oxygen fuel cell can also more specifically supply between about 75 and 90 cubic centimeters of hydrogen and oxygen gases per minute, per liters of engine displacement. Preferably, the hydrogen-oxygen fuel cell supplies about 80 cubic centimeters of hydrogen and oxygen gases per minute, per liters of engine displacement.

The hydrogen-oxygen fuel cell has a housing defining a base, side walls, and a cover. The cover has the gas outlet of the hydrogen-oxygen fuel cell extending therethrough. Conductive plates extend substantially from upward from the base, with an electrolyte solution disposed between the plates. A collection chamber is formed between the cover and the electrolyte solution.

The conductive plates can be spaced-apart and substantially parallel to each other. A communication channel can be formed in the base beneath the plates, and extending substantially transverse to the plates for fluid to pass between plates. The hydrogen-oxygen fuel cell can also have a fill port and a vent formed in the cover. The vent being operable to allow hydrogen and oxygen gases accumulating in the chamber to be released when the engine is not operating.

The plurality of plates can be a predetermined number to obtain a desired amount of hydrogen and oxygen gases from the hydrogen-oxygen fuel cell. The predetermined number can have, for example, about 125 square inches, 250 square inches, 500 square inches, 750 square inches, or 1000 square inches of surface area of the conductive plates for the electrolyte solution to interact with.

### BRIEF DESCRIPTION OF THE DRAWINGS

FIG. 1 is a schematic view of a hydrogen-oxygen generator constructed in accordance with this invention and connected to a diesel engine.

FIG. 2 is a sectional view of the hydrogen-oxygen generator of FIG. 1 taken along the line 2-2.

### DETAILED DESCRIPTION OF THE PREFERRED EMBODIMENT

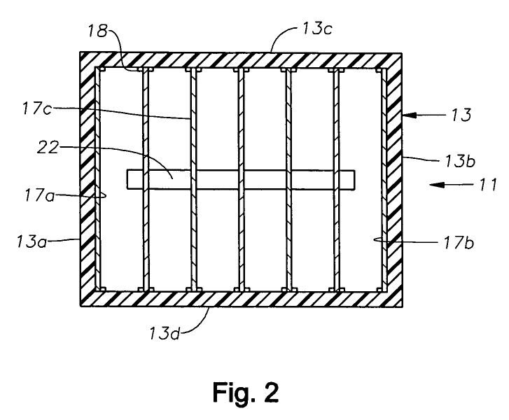

Hydrogen-oxygen generator 11 has a housing 13 preferably constructed of a durable plastic material. Housing 13 is preferably generally rectangular, having four orthogonal sidewalls 13a, 13b, 13c and 13d, as shown in FIG. 2. Housing 13 has a closed top 16 and an outlet port 15 at its top 16.

A number of electrically conductive plates 17 are mounted in housing 11 parallel to each other and equally spaced apart in the preferred embodiment. Each plate 17 is preferably of stainless steel and substantially identical to the other plates. Referring to FIG. 2, plates 17 are parallel to housing sidewalls 13a, 13b and perpendicular to sidewalls 13c, 13d. Vertical edges of plates 17 extend into slots in insulated retainers 18 on the inner sides of housing sidewalls 13c, 13d. If the material of housing 13 is a good electrical insulator, retainers 18 may be integrally formed with sidewalls 13c, 13d.

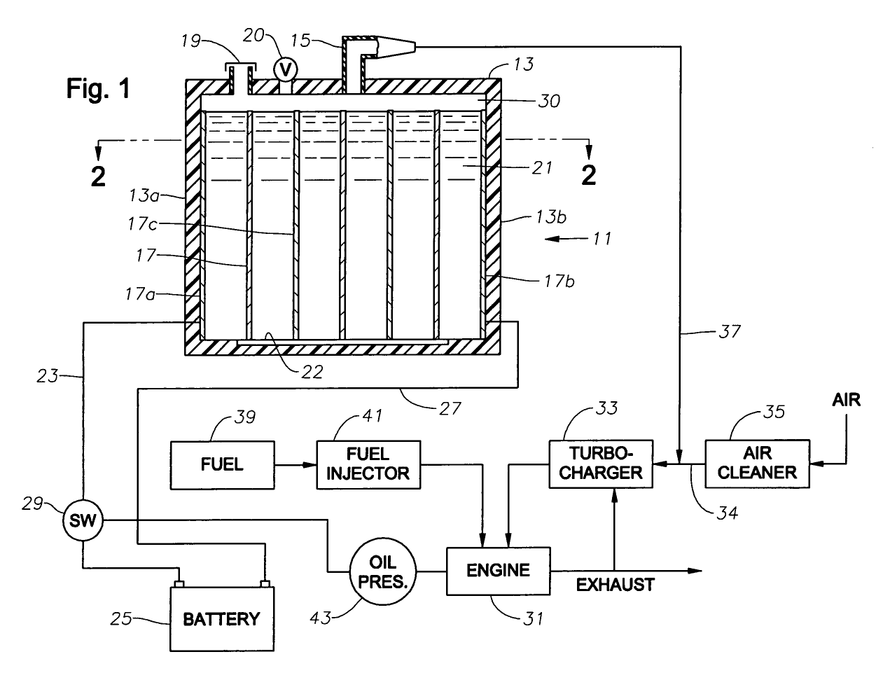

Referring again to FIG. 1, the upper edges of plates 17 are spaced a short distance below top 16. A fill port 19 is located in top 16 of housing 13 for introducing an electrolyte solution 21 into the spaces surrounding plates 17. Electrolyte solution 21 may vary, but is preferably potassium hydroxide and water. A vent 20 to atmosphere is also located in top 16, and it could be combined with the cap of fill port 19. Preferably, vent 20 contains a check valve that allows outward flow from housing 13 but stops any inward flow into housing 13. Initially, electrolyte solution 21 will be filled to substantially the upper edges of plates 17. One or more communication channels 22 are formed in the bottom of housing 13 to communicate electrolyte solution 21 freely between plates 17. Alternately, holes could be provided in some of the plates 17.

One plate 17a is mounted next to or in contact with sidewall 13a of housing 11, and another plate 17b is mounted next to or in contact with the opposite sidewall 13b. Plate 17a is connected by a cable or wire 23 to one terminal of a battery 25, such as the positive terminal. Plate 17b is connected by a wire 27 to the opposite or negative terminal of battery 25. The plates 17 located between plates 17a, 17b (referred to herein as plates 17c), are not directly connected to either the positive or negative terminal of battery 25 in this embodiment. One of the wires 23 or 27 contains a switch 29. In this embodiment, switch 29 opens and closes wire 23. When switch 29 is closed, the voltage differential between plates 17a, 17b, causes an electrical current to flow through electrolyte solution 21 and through plates 17c. The electrical current causes hydrogen and oxygen to be generated, which flows upward into a collection area 30 located above the level of electrolyte solution 21 and below top 16.

Hydrogen-oxygen generator 11 is adapted for use with a conventional engine that includes reciprocating pistons, valves and the like. The engine 31 depicted represents a diesel engine, but it could also be gasoline. Engine 31 optionally may have a turbocharger 33 of a type commonly employed with diesel engines. Turbocharger 33 draws air through a duct 34 that leads from an air cleaner 35, and forces the air into the intake of engine 31. Turbocharger 33 is driven by the exhaust of engine 31.

Hydrogen and oxygen generated by plate 17 flows from collection area 30 through outlet port 15 and into a duct 37 leading to duct 34 between turbocharger 33 and air cleaner 35. The suction of turbocharger 33 causes the flow of hydrogen and oxygen from housing 13 through duct 37. The hydrogen and oxygen mix with the air flowing from air cleaner 35.

The engine system has a fuel tank 39 connected to fuel injectors 41, which inject fuel into the intake of engine 31. The fuel mixes with the air, hydrogen and oxygen flowing into the intake of engine 31 and undergoes combustion in the cylinders of engine 31. An oil pressure sensor 43 senses the pressure of oil being circulated within engine 31 by a conventional oil pump (not shown). Oil pressure sensor 43 is connected to switch 29 to close switch 29 when it senses oil pressure.

In the operation of hydrogen-oxygen generator 11, when engine 31 is started, power is supplied to conductive plates 17a, 17b. Battery 25 is powered by an alternator (not shown) driven by engine 31. The voltage differential causes an electrical current to flow through electrolyte solution 21 and through plates 17c located between plates 17a, 17b. The electrical current reacts with all of the plates 17, generating hydrogen and oxygen. The hydrogen and oxygen will flow to the intake of engine 31 via turbocharger 33, if one is employed. The hydrogen and oxygen cause the fuel to burn more efficiently in engine 31. The improved efficiency creates more power, better fuel economy, and reduces particulate matter in the exhaust, such as carbon or soot.

If the oil pressure ceases, such as when engine 31 is shut down, sensor 43 opens switch 29 to terminate the voltage differential between plates 17a, 17b. The production of hydrogen and oxygen immediately ceases. Any residual hydrogen and oxygen in collection area 30 flows to atmosphere through the vent 20.

Hydrogen and oxygen will continue to be produced while engine 31 is running even though the level of electrolyte solution 21 drops. More electrolyte solution 21 can be added from time-to-time through fill port 19. Preferably, the volume of housing 13 is selected so that under normal operating conditions, refilling of electrolyte solution 21 is needed only at the same regular service intervals for changing oil.

The quantity of hydrogen-oxygen being produced by hydrogen-oxygen generator 11 must be matched to the size of engine 31 for best performance. Too much or too little production of hydrogen and oxygen will affect the performance. The amount of hydrogen-oxygen produced is a function of the area of plates 17, the specific gravity of electrolyte solution 21, and the voltage supplied. In one example, engine 31 is a conventional diesel engine having a 6.0 liter capacity. Battery 25 is a 12 volt battery. Seven plates 17 are used, each separated from the other by one-half inch. Electrolyte solution 21 comprises 1800 milliliters of distilled water mixed with 15 grams of potassium hydroxide.

Testing was performed with several engines with an engine dynamometer on vehicles and on an engine connected to a generator. The engines of several vehicles included Cummins™, Detroit M60™, and Caterpillar™ diesel engines. The engine connected to the generator was a 1.33 Liter diesel engine which was tested while connected to a generator having a 4 kilowatt load and an 8 kilowatt load. The emissions were tested using a six gas emission analyzer. Horsepower and gas efficiencies were determined using standard methods accepted by those skilled in the art. The opacity, or measure of particulate matter or soot associated with diesel engine emissions was also measured and recorded. Based upon these tests it was discovered that there was a range of hydrogen and oxygen gases measured in cubic centimeters per minute, for each liter of engine displacement in which horsepower increased while still increasing the reduction in emissions measured by opacity. These findings are illustrated below in Chart 1, which has the percent reduction in emissions (opacity) versus the cubic centimeters per minute, over the liters of engine displacement (c.c.p.m.p.l).

[image]

As can be seen by the chart, there is additional horsepower added when the ratio range of hydrogen and oxygen gases introduced into the airflow is between about 50 and 80 (c.c.p.m.p.l.). The horsepower substantially unchanged, with a slight increase and slight dropping off between 80 and 90 (c.c.p.m.p.l.), and there is a sharp decline in horsepower after 100 (c.c.p.m.p.l.) are added into the air flow. Preferably, between about 75 and 90 (c.c.p.m.p.l.) of hydrogen and oxygen gases are added to the air flow into the engine in order to obtain better reduction in emissions and increased horsepower. Preferably, about 80 (c.c.p.m.p.l.) of hydrogen and oxygen gases are added to the air flow into the engine in order to obtain the optimized reduction in emissions and increased horsepower.

Chart 2 below illustrates the amount of hydrogen and oxygen gases measured in cubic centimeters per minute that are necessary to obtain the desired ratio range of between 50 and 80 (c.c.p.m.p.l.) versus the number of liters of engine displacement. As is shown by Chart 2, it would require the fuel cell to supply 800 cubic centimeters of hydrogen and oxygen gases per minute to satisfy the needs of an engine having 16 liters of engine displacement, in order to obtain the ratio of 50 (c.c.p.m.p.l.). Similarly, it would require the fuel cell to supply approximately 1300 cubic centimeters of hydrogen and oxygen gases per minute to satisfy the needs of an engine having 16 liters of engine displacement, in order to obtain the ratio of 90 (c.c.p.m.p.l.).

[image]

The maximum output hydrogen and oxygen gases measured in cubic centimeters per minute versus the surface area of the conductor plates measured in square inches were also calculated. The results are illustrated in Charts 3 and 6 below. The maximum output obtained under ideal operating conditions of the fuel cell is illustrated in Chart 3. Chart 6 shows the results of testing under operating conditions for the amount of surface area covered by the electrolyte solution. As can be seen on Chart 6, it required approximately 1000 square inches of the surface area of the conductive plates to be covered in order to produce 1000 cubic centimeters per minute of hydrogen and oxygen gases. The results were substantially linear with approximately 500 square inches required to produce approximately 500 cubic centimeters per minute of hydrogen and oxygen gases.

[image]

The amount of added horsepower when operating with the optimum ratio of between 50 and 90 (c.c.p.m.p.l.) was also measured versus the liters of engine displacement. As shown in Chart 4 below, a six liter engine had an increase of approximately six horsepower, and sixteen liter engine had an increase of about 20 horsepower.

[image]

The reduction in fuel consumption was also measured. The test data is illustrated for the engine connected to the generator with a 4 kilowatt load, the engine connected to the generator with an eight kilowatt load, and for the variable rotations per minute engines with gearboxes (i.e., the engines in the vehicles). As can be seen in Chart 5, there was a reduction in fuel consumption for engines operating at a constant speed, as well as for engines operating at variable speeds. The percent reduction in fuel consumption was between four and eight percent.

[image]

When hydrogen and oxygen gases are introduced into the air intake of the engine in the ratio range of between about 50 and 90 (c.c.p.m.p.l.), the gases introduced into the chamber are immune from automatic detonation. When ignition occurs, the hydrogen and oxygen burns typically five times faster and flashes through the combustion chamber, thereby creating multiple ignition points that burn the hydrocarbon molecules from all sides. In other words, the hydrocarbons are forced to burn to the middle of each molecule rather than burning from one end to the other as in ordinary flame propagation. This increased combustion efficiency results in increased power, reduced emission, and a reduction in fuel consumption. Moreover, because the opacity, or the amount of particulate matter (i.e., soot) is reduced, less particulate matter accumulates in the engine, thereby reducing engine wear and oil dilution.

While the invention has been shown in only one of its forms, it should be apparent to those skilled in the art that it is not so limited, but is susceptible to various changes without departing from the scope of the invention. For example, all the examples pertained to diesel engines, however, the results can be applied to regular gasoline as well.

That claimed is:

1. A system for supplying power with a combustion engine, comprising:
a combustion engine having a fuel intake line, an air intake line, and an exhaust line, the fuel intake line receiving fuel from a fuel source, the air intake line receiving filtered air from an air source, the combustion engine having a combustion chamber volume defining a predetermined number of liters of engine displacement;
a hydrogen-oxygen fuel cell that selectively produces hydrogen and oxygen gases through an electrolysis process, having a gas outlet in fluid communication with the air intake line, the hydrogen-oxygen fuel cell supplying between about 50 and 90 cubic centimeters of hydrogen and oxygen gases per minute, per liters of engine displacement;
an oil pressure sensor in fluid communication with the combustion engine, the oil pressure sensor sensing when the combustion engine is operating;
a switch in communication with the oil pressure, the switch being in a closed position when the oil pressure sensor senses that the combustion engine is operating and in an open position when the oil pressure sensor senses that the combustion engine is not operating; and
a battery in electrical communication with the hydrogen-oxygen fuel cell that selectively supplies electrical power for the electrolysis process when the switch is in a closed position.

2. The system of claim 1, wherein the hydrogen-oxygen fuel cell supplies between about 75 and 90 cubic centimeters of hydrogen and oxygen gases per minute, per liters of engine displacement.

3. The system of claim 1, wherein the hydrogen-oxygen fuel cell supplies about 80 cubic centimeters of hydrogen and oxygen gases per minute, per liters of engine displacement.

4. The system of claim 1, further comprising an oil pressure sensor in fluid communication with the combustion engine, the oil pressure sensor sensing when the combustion engine is operating.

5. The system of claim 1, further comprising an oil pressure sensor in fluid communication with the combustion engine, the oil pressure sensor sensing when the combustion engine is operating; and
a switch in communication with the oil pressure, the switch being in a closed position when the oil pressure sensor senses that the combustion engine is operating and in an open position when the oil pressure sensor senses that the combustion engine is not operating, wherein the battery supplies electrical power for the electrolysis process when the switch is in a closed position.

6. The system of claim 1, wherein the hydrogen-oxygen fuel cell comprises:
a housing defining a base, side walls, and a cover, the cover having the gas outlet extending therethrough;
a plurality of conductive plates extending substantially from upward from the base;
an electrolyte solution disposed between the plates; and
a collection chamber formed between the cover and the electrolyte solution.

7. The system of claim 1, wherein the cover of the housing further comprises a vent having a check valve allowing outward flow of the hydrogen and oxygen gases from housing for venting the hydrogen and oxygen gases to the atmosphere when the engine is not operating.

8. The system of claim 1, wherein the fuel is at least one of a group consisting of diesel gasoline, biofuel, and synfuel.

9. A system for supplying power with a combustion engine, comprising:
a combustion engine having a fuel intake line, an air intake line, and an exhaust line, the fuel intake line receiving fuel from a fuel source, the air intake line receiving filtered air from an air source, the combustion engine having a combustion chamber volume defining a predetermined number of liters of engine displacement;
a hydrogen-oxygen fuel cell that selectively produces hydrogen and oxygen gases through an electrolysis process, having a gas outlet in fluid communication with the air intake line, the hydrogen-oxygen fuel cell comprising:
a housing defining a base, side walls, and a cover, the cover having the gas outlet extending therethrough;
a plurality of conductive plates extending substantially from upward from the base;
an electrolyte solution disposed between the plates; and
a collection chamber formed between the cover and the electrolyte solution; the system further comprising:
a battery in electrical communication with the plurality of conductive plates that selectively supplies electrical power for the electrolysis process when the engine is operating.

10. The system of claim 9, wherein the conductive plates are spaced-apart and substantially parallel to each other.

11. The system of claim 10, wherein the hydrogen-oxygen fuel cell further comprises a communication channel formed in the base, extending transverse to and beneath the conductive plates for the electrolyte solution to pass between the conductive plates.

12. The system of claim 9, wherein the cover of the housing further comprises a vent having a check valve allowing outward flow of the hydrogen and oxygen gases from housing for venting the hydrogen and oxygen gases to the atmosphere when the engine is not operating.

13. The system of claim 9, wherein the hydrogen-oxygen fuel cell supplies between about 75 and 90 cubic centimeters of hydrogen and oxygen gases per minute, per liters of engine displacement.

14. The system of claim 9, wherein the hydrogen-oxygen fuel cell supplies about 80 cubic centimeters of hydrogen and oxygen gases per minute, per liters of engine displacement.

15. The system of claim 9, further comprising an oil pressure sensor in fluid communication with the combustion engine, the oil pressure sensor sensing when the combustion engine is operating; and
a switch in communication with the oil pressure, the switch being in a closed position when the oil pressure sensor senses that the combustion engine is operating and in an open position when the oil pressure sensor senses that the combustion engine is not operating, wherein the battery supplies electrical power for the electrolysis process when the switch is in a closed position.

16. A system for supplying power with a combustion engine, comprising:
a combustion engine having a fuel intake line, an air intake line, and an exhaust line, the fuel intake line receiving fuel from a fuel source, the air intake line receiving filtered air from an air source, the combustion engine having a combustion chamber volume defining a predetermined number of liters of engine displacement;
a hydrogen-oxygen fuel cell that selectively produces hydrogen and oxygen gases through an electrolysis process, having a gas outlet in fluid communication with the air intake line, the hydrogen-oxygen fuel cell having a plurality of conductive plates defining a plate surface area, the hydrogen-oxygen fuel cell have a ratio of about 1 square in of plate surface area to one cubic centimeter per minute of the hydrogen and oxygen gases produced;
an oil pressure sensor in fluid communication with the combustion engine, the oil pressure sensor sensing when the combustion engine is operating;
a switch in communication with the oil pressure, the switch being in a closed position when the oil pressure sensor senses that the combustion engine is operating and in an open position when the oil pressure sensor senses that the combustion engine is not operating; and
a battery in electrical communication with the hydrogen-oxygen fuel cell that selectively supplies electrical power for the electrolysis process when the switch is in a closed position.

17. The system of claim 16, wherein the hydrogen-oxygen fuel cell supplies between about 80 and 90 cubic centimeters of hydrogen and oxygen gases per minute, per liters of engine displacement.

18. The system of claim 16, wherein the hydrogen-oxygen fuel cell supplies between about 75 and 90 cubic centimeters of hydrogen and oxygen gases per minute, per liters of engine displacement.

19. The system of claim 16, wherein the hydrogen-oxygen fuel cell supplies about 80 cubic centimeters of hydrogen and oxygen gases per minute, per liters of engine displacement.

20. The system of claim 16, further comprising an oil pressure sensor in fluid communication with the combustion engine, the oil pressure sensor sensing when the combustion engine is operating.
